(19) United States
(12) Patent Application Publication
(10) Pub. No.: US 2024/0052113 A1
(43) Pub. Date: Feb. 15, 2024

(54) ANTIBACTERIAL AND ANTIVIRAL MOLDED BODY, AND MASTER BATCH

(71) Applicant: MITSUI CHEMICALS TOHCELLO, INC., Tokyo (JP)

(72) Inventors: Junichi NARITA, Tokyo (JP); Katsunobu NAKAYAMA, Ibaraki (JP); Kunihiko TANAKA, Ibaraki (JP)

(21) Appl. No.: 18/258,129

(22) PCT Filed: Dec. 16, 2021
(86) PCT No.: PCT/JP21/46535

§ 371 Date: Jun. 16, 2023

(30) Foreign Application Priority Data
Dec. 18, 2020 (JP) 2020-210195

(51) Int. Cl. C08J 3/22; C08K 5/053; C08K 5/17; B65D 65/38

(52) U.S. Cl. CPC C08J 3/226; C08K 5/053; C08K 5/17; B65D 65/38; C08J 2323/06; B65D 2565/381

(57) ABSTRACT

To compound antibacterial and antiviral ingredients including stearyldiethanolamine in resin molded bodies with high uniformity and stability beyond the limits of conventional technology. The object can be accomplished by a resin molded body comprising a polymer resin, and stearyldiethanolamine and palmityldiethanolamine, wherein the content of palmityldiethanolamine is 2 to 25 parts by mass based on 100 parts by mass of the sum of the stearyldiethanolamine and the palmityldiethanolamine, and the polymer resin comprises a polyolefin or a polyamide.

### TECHNICAL FIELD

The present invention relates to resin molded bodies having antibacterial and antiviral performance, and to masterbatches that can be suitably used in resin molded bodies having antibacterial and antiviral performance.

### BACKGROUND ART

Polymer resins have various advantages, such as light weight, formability, and cost, and are widely used in various applications, such as sheets, injection molded bodies, and blow molded bodies.

In the above applications, antibacterial and antiviral properties are sometimes required, and various components with antibacterial and antiviral properties are blended into polymer resin molded bodies (see, for example, Patent Literatures 1 to 3.).

For example, in Patent Literature 1, it is proposed to have a specific compound, such as stearyldiethanolamine, present on the surface of a polymer film to give the polymer film antibacterial properties.

However, it is not necessarily easy to uniformly and stably compounding stearyldiethanolamine and other substances in resin molding bodies and to make appropriate amounts thereof stably present on the surface. Especially, when compounding into resin molding bodies having various shapes, such as sheets, injection molded bodies, foams, and blow molded bodies, thicknesses, and foaming ratios; when compounding with a masterbatch in which compounding concentration varies significantly; and so on, there is a strong need to improve the uniformity and bleed out property of stearyldiethanolamine, etc. In addition, there is a strong need to promote bleed out as far as it does not adversely affect the appearance of the molded product, and to compound stearyldiethanolamine with even higher stability.

### CITATION LIST

### Patent Literatures

PATENT LITERATURE 1: WO 2014/142218 A1
PATENT LITERATURE 2: JP H10-271981 A
PATENT LITERATURE 3: JP H10-045410 A

### SUMMARY OF INVENTION

### Technical Problem

In view of the above requirements, the object of the present invention is to compound antibacterial and antiviral ingredients, including stearyldiethanolamine, into resin molded bodies containing polyolefin or polyamide with high uniformity and stability and have them bled out exceeding the limits of conventional technology.

### Solution to Problem

As a result of intensive investigation, the inventors have found that the above problem can be solved by setting the mixing ratio of stearyldiethanolamine and palmityldiethanolamine within a specific range, leading to the completion of the present invention.

In other words, the present invention is:

[1] A resin molded body comprising a polymer resin, and stearyldiethanolamine and palmityldiethanolamine, wherein the content of palmityldiethanolamine is 2 to 25 parts by mass based on 100 parts by sum of the total of the stearyl diethanolamine and the palmityldiethanolamine, wherein the polymer resin comprises a polyolefin or a polyamide.

The following [2] to [8] each are one of the preferred embodiments of the present invention.

[2] The resin molded body according to [1], wherein the polymer resin comprises at least one selected from the group consisting of polyethylene, polypropylene and nylon.

[3] The resin molded body according to [1] or [2], wherein the resin molded body is a sheet, an injection molded body, a foam or a blow molded body.

[4] The resin molded body according to any one of [1] to [3], wherein the total content (in terms of mass) of the stearyldiethanolamine and the palmityldiethanolamine is from 50 ppm to 5.0%.

[5] A process for producing a resin molded body according to any one of [1] to [4], comprising the step of further mixing a masterbatch comprising polymer resin 1, which is a polyolefin or a polyamide, and stearyldiethanolamine and palmityldiethanolamine, wherein the palmityldiethanolamine content is 2 to 25 parts by mass based on 100 parts by mass of the sum of the stearyldiethanolamine and the palmityldiethanolamine; with polymer resin 2 which is polyolefin or a polyamide.

[6] The method for producing a resin molded body according to [5], wherein the masterbatch comprises 3 to 30 mass % of the sum of the stearyldiethanolamine and the palmityldiethanolamine.

[7] A masterbatch comprising polymer resin 1, which is a polyolefin or a polyamide, and stearyldiethanolamine and palmityldiethanolamine, wherein the palmityldiethanolamine content is 2 to 25 parts by mass based on 100 parts by mass of the sum of the stearyldiethanolamine and the palmityldiethanolamine.

[8] The masterbatch according to [7], containing 3 to 30% by mass of the sum of the stearyldiethanolamine and palmityldiethanolamine.

### Advantageous Effects of Invention

According to the present invention, various resin molded bodies, including sheets, injection molded bodies, foams or blow molded bodies, in which stearyldiethanolamine and so on, are compounded in polyolefin or polyamide resin molded bodies with excellent antibacterial and antiviral performance and high uniformity, bleed out property, and stability beyond the limits of conventional technology, can be provided.

In addition, according to one embodiment of the present invention, it is possible to provide a masterbatch suitable for use in the production of sheets, injection molded bodies, foams, blow molded bodies or the like, in which stearyldiethanolamine and so on are compounded in a polyolefin or polyamide resin molded body with high uniformity, bleed out property and stability beyond the limits of conventional technology, can be provided.

### BRIEF DESCRIPTION OF DRAWINGS

FIG. 1 is a schematic diagram showing part of the specimen preparation process in one example of the present invention.

### DESCRIPTION OF EMBODIMENTS

Embodiments for carrying out the present invention are described as follows.

The present invention is a resin molded body comprising a polymer resin, and stearyldiethanolamine and palmityldiethanolamine, wherein the content of palmityldiethanolamine is 2 to 25 parts by mass based on 100 parts by mass of the sum of the stearyl diethanolamine and the palmityldiethanolamine, wherein the polymer resin comprises a polyolefin or a polyamide.

In other words, the resin molded body of the present invention comprises polymer resin, as well as stearyldiethanolamine and palmityldiethanolamine.

Polymer Resin

There is no particular limitation on the polymer resin that constitutes the resin molded body of the present invention except that it comprises polyolefin or polyamide, and any polymer resin conventionally used in the production of resin molded bodies can be used as appropriate. The polymer resin as a whole may be a thermoplastic resin or a thermosetting resin, but a thermoplastic resin is preferred because it is applicable to various molding processes and is easy to mold.

Examples of the polyolefin includes homopolymers and copolymers of α-olefins, such as ethylene, propylene, 1-butene, 1-hexene, 4-methyl-1-pentene, and 1-octene. Specific examples include ethylene polymers, such as high-pressure low-density polyethylene, linear low-density polyethylene (LLDPE), and high-density polyethylene; propylene polymers, such as propylene homopolymer, propylene-α-olefin random copolymer and propylene block copolymer; poly 1-butene; poly 4-methyl-1-pentene and so on.

Examples of the polyamide include polyamides that contain aliphatic skeleton (commonly referred to as nylon), polyamides that contain only aromatic skeleton (commonly referred to as aramid), and the like.

In addition to polyolefins and/or polyamides, polyesters, such as polyethylene terephthalate, polybutylene terephthalate, polyethylene naphthalate and so on; polyvinyl chloride; polyimides; ethylene-vinyl acetate copolymers or saponified products thereof; polyvinyl alcohol; polyacrylonitrile; polycarbonate; polystyrene; ionomers; biodegradable resins, such as polylactic acid, polybutylene succinate, and so on; or mixtures thereof, etc. can be concurrently used as the thermoplastic resin.

Examples of the thermosetting resin include epoxy resins, unsaturated polyester resins, vinylester resins, acrylic resins, phenolic resins, urea resins, melamine resins, aniline resins, polyimide resins, bismaleimide resins and so on. Any of these thermosetting resins may be used alone, or in combination of two or more species. The thermosetting resin may also be used in combination with a curing agent.

The thermoplastic resin and the thermosetting resin may be used together.

Among the above polyolefins, polyethylene and/or polypropylene are particularly preferred. Among the above polyamides, nylon is particularly preferred.

These particularly preferred polymer resins have excellent moldability, mechanical properties, chemical stability, and light weight. They are also superior in cost, supply stability, quality stability, practicality, etc., since they are already used as general-purpose resins in many applications.

Polyethylene

The above polyethylene is not limited to polyethylene in the narrow sense, and ethylene polymers in general can be used.

Ethylene polymers include ethylene homopolymer, copolymers of ethylene as a major monomer and at least one α-olefin having carbon number of from 3 to 8, ethylene-vinyl acetate copolymer, its saponified derivatives and ionomers. Specifically, those having ethylene as the major monomer, including homopolymer thereof or copolymer thereof with at least one α-olefin having carbon number of from 3 to 8, such as ethylene homopolymer, ethylene-propylene copolymer, ethylene-1-butene copolymer, ethylene-1-pentene copolymer, ethylene-1-hexene copolymer, ethylene-4-methyl-1-pentene copolymer and ethylene 1-octene copolymer, can be exemplified. The α-olefin content in these copolymers is preferably 1 to 15 mol %.

Furthermore, preferred examples of said polyethylene include polyethylene in the narrow sense, i.e., a polymer of ethylene that is manufactured and sold under the name of “polyethylene”. Specifically, high-pressure low-density polyethylene (LDPE), linear low-density polyethylene (LLDPE), and high-density polyethylene (HDPE) are preferred, with LLDPE being more preferred. LLDPE is a copolymer of ethylene and a small amount of propylene, butene-1, heptene-1, hexene-1, octene-1,4-methyl-pentene-1 or the like. Polyethylene in the narrow sense may also be a homopolymer of ethylene or a polymer of ethylene as the main component, such as LLDPE.

The density of the polyethylene is preferably 0.910 to 0.940 g/cm³, and 0.920 to 0.930 g/cm³ is more preferred. The density of 0.910 g/cm³ or higher improves heat sealing property. The density of 0.940 g/cm³ or less improves processability and transparency.

There are no restrictions on the method for producing polyethylene, and it can be produced by methods known to those skilled in the art. For example, it may be produced using heterogeneous catalysts, such as Ziegler-Natta catalysts, or homogeneous catalysts, such as metallocene catalysts.

Polypropylene

As the polypropylene, propylene polymers in general can be used.

Propylene polymers include crystalline polymers having propylene as the main component and produced and sold under the name of “polypropylene”, such as propylene homopolymers (also referred to as “homo PP”), propylene-α-olefin random copolymers (also referred to as “random PP”), and blends of propylene homopolymer and low crystallinity or amorphous propylene-ethylene random copolymer (also referred to as “block PP”). The propylene polymer may be a mixture of propylene homopolymers having different molecular weights, or a mixture of a propylene homopolymer and a random copolymer of propylene and ethylene or an α-olefin having carbon number of from 4 to 10.

Examples of polypropylene includes copolymers of propylene as the main monomer and at least oneα-olefin(s) selected from the α-olefins having carbon number of from 4 to 10, such as polypropylene, propylene-ethylene copolymer, propylene-ethylene-1-butene copolymer, propylene-1-butene copolymer, propylene-1-pentene copolymer, propylene 1-hexene copolymer and propylene 1-octene copolymer. These can be used either alone or in combination of two or more species.

The density of polypropylene is preferably 0.890 to 0.930 g/cm³ and more preferably 0.900-0.920 g/cm³. The MFR (ASTM D1238, load: 2,160 g, temperature: 230° C.) of the polypropylene is preferably 0.5 to 60 g/10 min., more preferably 0.5 to 10 g/10 min. is more preferred, and even more preferably 1 to 5 g/10 min.

Polyethylene Terephthalate

Polyethylene terephthalate, an optional component, is a polyester obtained from terephthalic acid as the major acid component and ethylene glycol as the major glycol component and may be a homopolymer (a polyester derived from only terephthalic acid and ethylene glycol). It also can be a copolymer consisting of a major amount, e.g., 90 mol % or more, of ethylene terephthalate repeating units and the remainder, e.g., 10 mol % or less, of other copolymerizable components capable of forming ester bond. Examples of copolymerizable compounds include dicarboxylic acids, such as isophthalic acid, cyclohexanedicarboxylic acid, adipic acid, dimeric acid, and sebacic acid, as the acid component; and diethylene glycol, butanediol, neopentyl glycol, and cyclohexanedimethanol, polyethylene glycol, polypropylene glycol and so on as the glycol component.

The intrinsic viscosity [η] of polyethylene terephthalate should be selected as appropriate according to the type and shape of the resin molded body, but is usually from 0.60 to 0.75 dl/g. The intrinsic viscosity is more preferably 0.62 to 0.67 dl/g.

While polyethylene terephthalate can be either crystalline or amorphous, amorphous polyethylene terephthalate (APET) is preferred.

Only one species of polyethylene terephthalate may be used alone, or two or more species can be used in combination. Polyethylene terephthalate may also be used in combination with other aromatic polyesters, or in combination with aliphatic polyesters, such as polylactic acid or polybutylene succinate.

Polystyrene

Examples of polystyrene as an optional component includes, homopolymers of a styrenic monomer (e.g., styrene, methylstyrene, ethylstyrene, isopropylstyrene, dimethylstyrene, para-methylstyrene, chlorostyrene, bromostyrene, vinyltoluene and vinylxylene); copolymers of a styrenic monomer and a monomer that can copolymerize with a styrenic monomer (hereinafter, referred to as “modified polystyrene”). Examples of the monomers that can copolymerize with a styrenic monomer include, vinyl monomers (e.g., acrylonitrile, methacrylonitrile, acrylic acid, methacrylic acid, methyl methacrylate, maleic anhydride, butadiene) and so on.

Examples of the modified polystyrene includes, acrylonitrile-styrene copolymer (AS), methyl methacrylate-styrene copolymer, acrylonitrile-methyl methacrylate-styrene copolymer, acrylonitrile-butadiene-styrene copolymer (ABS), acrylonitrile-acrylic rubber-styrene copolymer (AAS), acrylonitrile ethylene propylene diene rubber-styrene copolymer (AES).

Only one species of polystyrene may be used alone, or two or more species may be used in combination.

Nylon

Nylon, which is particularly suitable as a polyamide mentioned above, is not limited to nylon in the narrow sense, i.e., polymer resins manufactured and sold under the name “nylon”, and polyamide resins that contain an aliphatic skeleton in general can be preferably used.

More specifically, 4-nylon, 6-nylon, 7-nylon, 11-nylon, 12-nylon, 46-nylon, 66-nylon, 69-nylon, 610-nylon, 611-nylon, 612-nylon, 6T-nylon, 61-nylon, copolymerized nylon, amorphous nylon, etc. can be exemplified. Among these, 6-nylon, 12-nylon, 66-nylon, copolymerized nylon, and amorphous nylon are preferably used because of their heat resistance, mechanical strength, and availability.

Specific examples of the copolymerized nylon include copolymers of 6-nylon and 66-nylon (Nylon 6/66), copolymers of 6-nylon and 610 nylon, copolymers of 6-nylon and 611-nylon, copolymers of 6-nylon and 12-nylon (Nylon 6/12), copolymers of 6-nylon and 612-nylon, copolymers of 6-nylon and 6T-nylon, copolymers of 6-nylon and 61-nylon, copolymers of 6-nylon, 66-nylon and 610-nylon, copolymers of 6-nylon, 66-nylon and 12-nylon (Nylon 6/66/12), copolymers of 6-nylon, 66-nylon and 612-nylon, copolymers of 66-nylon and 6T-nylon, copolymers of 66-nylon and 61 nylon, copolymers of 6T-nylon and 61-nylon, and copolymers of 66-nylon, 6T-nylon, and 61-nylon and so on. Only one species of the nylon can be used alone, or two or more species can be used in combination.

Stearyldiethanolamine and Palmityldiethanolamine

In the resin molded body of the present invention, the inclusion of stearyldiethanolamine and palmityldiethanolamine can impart antibacterial and antiviral properties to the resin molded body.

Stearyldiethanolamine is an alkyl diethanolamine having a stearyl group, whose carbon number is 18.

Palmityldiethanolamine is an alkyl diethanolamine having a palmityl group, a long-chain alkyl group whose carbon number is 16.

Stearyldiethanolamine and palmityldiethanolamine have excellent antibacterial and antiviral properties and have a relatively high melting point in comparison with myristyldiethanolamine and lauryldiethanolamine, making them less volatile during molding and can maintain the aforementioned antibacterial and antiviral properties for relatively long period, and hence they have been conventionally used to impart antibacterial and antiviral properties to polyethylene films and so on.
(alkyl diethanolamine; number of carbons in the long-chain alkyl group portion; melting point)
Stearyldiethanolamine; 18; 51° C.
Palmityldiethanolamine; 16; 28° C.
Myristyldiethanolamine; 14; 22 to 23° C.
Lauryldiethanolamine; 12; liquid at room temperature

In general, stearyldiethanolamine (18 carbons) may contain various similar compounds, including alkyl diethanolamines with alkyl groups of 16 to 20 carbons. Examples of the alkyl diethanolamines having alkyl groups of 16 to 20 carbons mentioned above include palmityldiethanolamine (16 carbons), myristyldiethanolamine (14 carbons), and so on. These similar compounds are generally synthesized simultaneously in the process of the synthesis and the separation of stearyldiethanolamine.

In the present invention, among these compounds similar to stearyldiethanolamine, the content of palmityldiethanolamine is adjusted within a specific range, focusing on the effect of the content of palmityldiethanolamine on the stability of stearyldiethanolamine compounded in the resin molded body.

More specifically, in the resin molded body of the present invention, the content of palmityldiethanolamine is 2 to 25 parts by mass based on 100 parts by mass of the sum of stearyldiethanolamine and palmityldiethanolamine. By having the palmityldiethanolamine content falling within the above range, the stability of stearyldiethanolamine compounded in the resin molded body is greatly improved, and bleeding-out and so on, which adversely affect the appearance of the molded body, can be effectively suppressed.

When the content of palmityldiethanolamine is 2 parts by mass or more based on 100 parts by mass of the sum of stearyldiethanolamine and palmityldiethanolamine, high bleeding-out promotion performance is achieved in the resin molded body. The content of palmityldiethanolamine is preferably 5 parts by mass or more based on 100 parts by mass of the sum of stearyldiethanolamine and palmityldiethanolamine, and more preferably 8 parts by mass or more.

When the content of palmityldiethanolamine is 25 parts by mass or less based on 100 parts by mass of the sum of stearyldiethanolamine and palmityldiethanolamine, stickiness on the surface of the resin molded body, preferably a sheet, injection molded body, foam, or blow molded body, is suppressed. Furthermore, it is possible to suppress the fuming of palmityldiethanolamine, which has a low volatility temperature, at the time of molding.

The content of palmityldiethanolamine is preferably 23 parts by mass or less, and more preferably 20 parts by mass or less, based on 100 parts by mass of the sum of stearyldiethanolamine and palmityldiethanolamine.

The mechanism by which a high bleed out promotion performance is achieved in resin molded bodies containing polyolefin or polyamide when the content of palmityldiethanolamine is above the specific value relative to the total amount of stearyldiethanolamine and palmityldiethanolamine is not necessarily clear. However, it is presumed to be related to that, in the case of a resin molded body containing polyolefin, the solubility parameter (SP value) of the mixture of stearyldiethanolamine and palmityldiethanolamine increases as the palmityldiethanolamine content increases, which leads to the decrease in compatibility with the polyolefin as the difference between the solubility parameter of the mixture and the solubility parameter of the polyolefin-containing resin that constitutes the resin molded body increases.

More specifically, the solubility parameter (SP value) of a mixture of stearyldiethanolamine (C18 DEA) and palmityldiethanolamine (C16 DEA) varies depending on the mixing ratio of the two components, as shown in Table 1 below.

TABLE 1

| | Mixture 1 | Mixture 2 | Mixture 3 | Mixture 4 | Mixture 5 |
|---|---|---|---|---|---|
| C18DEA | 100 | 95 | 90 | 85 | 0 |
| (parts by mass) | | | | | |
| C16DEA | 0 | 5 | 10 | 15 | 100 |
| (parts by mass) | | | | | |
| SP value | 10.37 | 10.38 | 10.39 | 10.39 | 10.52 |

On the other hand, most polyolefin-containing polymer resins have solubility parameters that are smaller than those of stearyldiethanolamine and palmityldiethanolamine. For example, since the solubility parameter of the preferred polyolefin, polyethylene, is 7.7 to 8.4, and that of polypropylene is 8.0-8.7, the difference between the solubility parameter of the mixture and that of the polymer resin increases as the content of palmityldiethanolamine increases in the mixture of stearyldiethanolamine and palmityldiethanolamine, and this is presumed to promote the bleed out.

The inventors also found that when palmityldiethanolamine is added to stearyldiethanolamine in the amount specified in the present invention, the kinematic viscosity of the resulting mixture decreases. It is also presumed that this promotes bleed out onto the surface of the molded body, since the mixture can move more quickly through the resin when the kinematic viscosity is reduced.

In the case of resin molded bodies containing a polyamide, most of polyamides have a solubility parameter significantly larger than those of stearyldiethanolamine and palmityldiethanolamine. For example, since the solubility parameter of nylon 66, a preferred polyamide, is 13.6, the effect of the increase in solubility parameter due to the increase in palmityldiethanolamine content in a mixture of stearyldiethanolamine and palmityldiethanolamine is small, and the viscosity decrease rather has a dominant effect, which is presumed to promote bleed out.

The content of palmityldiethanolamine can be adjusted (or controlled) by adjusting the conditions in the production of stearyldiethanolamine, for example, by properly controlling the distillation conditions of raw materials, beef tallow or vegetable oil mixture.

A predetermined amount of separately produced palmityldiethanolamine may also be added after the production of stearyldiethanolamine.

As long as the condition that the content of palmityldiethanolamine is 2 to 25 parts by mass based on 100 parts by mass of the sum of stearyldiethanolamine and palmityldiethanolamine is met, there are no particular limitations on the content of palmityldiethanolamine and the content of stearyldiethanolamine in the resin molded body, and the contents can be determined appropriately according to the type and application of the resin molded body, such as a sheet, a film, an injection molded body, a foam, or a blow molded body.

Typically, the contents of palmityldiethanolamine and stearyldiethanolamine in total in a resin molded body, which is a sheet, a film, an injection molded body, a foam or a blow molded body, is preferably 50 ppm to 5.0% (by mass).

The total content of palmityldiethanolamine and stearyldiethanolamine of 50 mass ppm or more is preferable because the resin molded body of this embodiment, which is a sheet, a film, an injection molded body, a foam or a blow molded body, can express appropriate antibacterial and antiviral performance by virtue of it. It is more preferable that the total content of palmityldiethanolamine and stearyldiethanolamine be 100 mass ppm or more, and it is especially preferable that the total content be 300 mass ppm or more.

The total content of palmityldiethanolamine and stearyldiethanolamine of 5.0 mass % or less is preferable, because the resin molded body of this embodiment can suppress excessive bleed out, suppress deterioration of appearance, and suppress excessive migration to the contents by virtue of it. It is more preferable that the total content of palmityldiethanolamine and stearyldiethanolamine be 2 mass % or less, and it is especially preferable that the total content be 1 mass % or less.

The contents of palmityldiethanolamine and stearyldiethanolamine in the resin molded body can be measured by extraction tests after ultrasonic pulverization, etc.

The contents of palmityldiethanolamine and stearyldiethanolamine in the resin molded body can be adjusted by adjusting the amounts of palmityldiethanolamine and stearyldiethanolamine added during molding process and the amount of pelletized resin molded product (masterbatch) used and so on.

When the resin molded body consists of or mainly consists of polyethylene, the total content of palmityldiethanolamine and stearyldiethanolamine is preferably from 0.01 to 3% by mass.

When the resin molded body consists of or mainly consists of polypropylene, the total content of palmityldiethanolamine and stearyldiethanolamine is preferably from 0.01 to 3% by mass.

When the resin molded body consists of or mainly consists of polyamide, the total content of palmityldiethanolamine and stearyldiethanolamine is preferably from 0.02 to 1.0 mass %.

The resin molded body of the present invention may contain component(s) other than polymer resin, palmityldiethanolamine and stearyldiethanolamine.

For example, it may contain a component having antibacterial and antiviral performance other than palmityldiethanolamine and stearyldiethanolamine. Examples of these components with antibacterial and antiviral properties include alkyldiethanolamines other than palmityldiethanolamine and stearyldiethanolamine, compounds in which a portion of an alkyldiethanolamine forms an ester with an aliphatic carboxylic acid, higher aliphatic alcohols, glycerol fatty acids, diglycerol fatty acids and so on.

In addition to components having antibacterial and antiviral performance, additives, such as heat stabilizers (antioxidants), weathering stabilizers, UV absorbers, lubricants, slip agents, nucleating agents, antiblocking agents, antistatic agents, antifogging agents, pigments, and dyes, may be added as needed. Various fillers, such as talc, silica, diatomaceous earth, etc. may also be added.

As heat stabilizers, for example, phenolic antioxidants, such as 3,5-di-t-butyl-4-hydroxytoluene, tetrakis[methylene(3,5-di-t-butyl-4-hydroxy)hydrocinnamate]methane, n-octadecyl-3-((4′-hydroxy-3,5-di-t-butylphenyl) propionate and 2,2′-methylenebis(4-methyl-6-t-butylphenol); benzophenone antioxidants, such as 2-hydroxy-4-methoxybenzophenone, 2-hydroxy-4-octoxybenzophenone and 2,4-dihydroxybenzophenone; benzotriazole antioxidants, such as 2-(2′-hydroxy-5-methylphenyl)benzotriazole and substituted benzotriazole; 2-ethylhexyl-2-cyano-3,3-diphenyl acrylate, ethyl 2-cyano-3,3-diphenylacrylate, phenyl salicylate, 4-t-butylphenylsalicylate, and so on can be listed as preferable examples. One of these may be used alone, or two or more of them may be used in combination.

As antistatic agents, for example, alkylamines and their derivatives, higher alcohols, pyridine derivatives, sulfated oils, soaps, olefin sulfates, alkyl sulfates, fatty acid ethyl sulfonates, alkyl sulfonates, alkyl naphthalene sulfonates, alkyl benzene sulfonates, naphthalene sulfonates, amber ester sulfonates, phosphates, partial fatty acid esters of polyhydric alcohols, ethylene oxide adducts of fatty alcohols, ethylene oxide adducts of fatty acids, ethylene oxide adducts of fatty amines or fatty acid amides, ethylene oxide adducts of alkylphenols, ethylene oxide adducts of alkylnaphthols, ethylene oxide adducts of partial fatty acid esters of polyhydric alcohols, polyethylene glycol and so on can be listed as preferred examples. One of these may be used alone, or two or more of them may be used in combination.

Stearic acid, stearic acid amide, oleic acid amide, higher alcohols, and liquid paraffin, for example, are preferred examples of lubricants. One of these may be used alone, or two or more of them may be used in combination.

As UV absorbers, for example, ethylene-2-cyano-3,3′-diphenyl acrylate, 2-(2′-hydroxy-5′-methylphenyl)benzotriazole, 2-(2′-hydroxy-3′-t-butyl-5′-methylphenyl)-5-chlorobenzotriazole, 2-hydroxy-4-methoxybenzophenone, 2,2′-dihydroxy-4-methoxybenzophenone, 2-hydroxy-4-octoxybenzophenone and so on can be listed as preferred examples. One of these may be used alone, or two or more of them may be used in combination.

Resin Molded Body

There are no particular limitations on the type, shape, etc. of the molded body of the present invention, and it can be applied preferably to various molded bodies of various shapes. But it can be especially preferably applied to resin molded bodies, such as sheets, injection molded bodies, foamed bodies, and blow molded bodies, of various shapes, thicknesses, and foam magnifications.

In the conventional technology, components with antibacterial and antiviral performance, such as stearyldiethanolamine, were mostly added to films having relatively small thickness, and embodiments suitable for compounding in films have been studied. Since sheets, injection-molded bodies, foams, blow-molded bodies, etc. have different shapes, dimensions (thickness), and foaming ratios from films and their molding processes are also different from those of films, it is not necessarily easy to compound stearyldiethanolamine or the like uniformly and stably in the molded body and have it bled out stably if the conventional technology is applied directly to these molded products.

In the present invention, by virtue of using stearyldiethanolamine and palmityldiethanolamine and setting the content of palmityldiethanolamine to 2 to 25 parts by mass based on 100 parts by mass of the sum of stearyldiethanolamine and palmityldiethanolamine, reasonable amounts of stearyldiethanolamine and palmityldiethanolamine can be compounded in the resin molded body uniformly and stably without stickiness during the molding process, even in the case of a sheet, an injection molded body, a foam, a blow molded body, etc., to provide sufficient antibacterial performance to the resin molded body in a stable manner and a good appearance of the resin molded body can be achieved

Masterbatch

In the production of the resin molded bodies of the present invention, although stearyldiethanolamine and palmityldiethanolamine in amounts that satisfy the conditions of the present invention may be compounded directly into the polymer resin, it is preferable to prepare a resin molded body (i.e., masterbatch) in pellet form containing appropriate amounts of stearyldiethanolamine and palmityldiethanolamine (and other additives as needed) and mix the masterbatch with polymer resin so that the amounts of palmityldiethanolamine and palmityldiethanolamine in the final resin-molded product will be within the desired ranges because, if stearyldiethanolamine and palmityldiethanolamine are used as is, weighing during molding may not be stable.

In this embodiment, by virtue of comprising stearyldiethanolamine and palmityldiethanolamine in a predetermined ratio, the masterbatch of stearyldiethanolamine and palmityldiethanolamine has appropriate compatibility (or incompatibility) for bleeding out with the resin constituting the resin molded body and good fluidity, which allows the stearyldiethanolamine and palmityldiethanolamine to diffuse uniformly in the resin molded body, even when manufacturing a resin molded body using a masterbatch with greatly fluctuating compounding concentrations.

Also, to improve handling properties, stearyldiethanolamine and palmityldiethanolamine may be pre-adsorbed on zeolite and then kneaded into resin.

In this embodiment, it is preferable to use a masterbatch comprising a resin that constitutes the masterbatch (polymer resin 1, which is a polyolefin or a polyamide), and stearyldiethanolamine and palmityldiethanolamine, wherein the palmityldiethanolamine content is 2 to 25 parts by mass based on 100 parts by mass of the sum of the stearyldiethanolamine and the palmityldiethanolamine.

By mixing the above masterbatch with the resin that constitutes the resin molded body (polymer resin 2, which is a polyolefin, or a polyamide), and then subjecting it to the molding process after or simultaneously with the mixing, it is possible to produce a resin molded body in which stearyl diethanolamine and palmityldiethanolamine are uniformly diffused.

Although there is no particular limits on the concentrations of stearyldiethanolamine and palmityldiethanolamine in said masterbatch, it is preferable to contain 3 to 30% by mass of stearyldiethanolamine and palmityldiethanolamine in total, and 5 to 20% by mass is particularly preferable.

Since the resin molded body of the present invention has antibacterial and antiviral performances, it can be molded and processed to a variety of products that require antibacterial and antiviral performances.

For example, when the resin molded material is a sheet, it can be suitably used for civil engineering and construction materials, building interior materials, automobile interior materials, store and desk boundaries, refrigerator curtains, refrigerator curtains, etc. to avoid viruses.

When the resin molded body is a foam molded body, it can be suitably used for heat insulating materials, packaging materials, cushioning materials, disposable containers, fruit packaging materials, etc.

When the resin molded body is a blow molded body, it can be suitably used for bottles, packaging materials, disposable sanitary containers, food containers, etc.

When the resin molded body is an injection molded body, it can be suitably used for various parts, cutting boards, disposable containers, disposable chopsticks, spoons, etc.

### Examples

The present invention will be explained in detail below with reference to examples/comparative examples. The present invention is not limited in any sense by the following examples.

I. Evaluation of Mixture of Stearyldiethanolamine and Palmityldiethanolamine

The following stearyldiethanolamine and palmityldiethanolamine were used to produce mixtures thereof, and their fluidity (melt viscoelasticity) was measured and compared with that of stearyldiethanolamine.

(1) Stearyldiethanolamine
Melting point: 51° C.
Boiling point: 260-285° C. (pressure: 5 Torr)
Density: 0.8782 g/cm³ (Temperature: 50° C.)

(2) Palmityldiethanolamine
Melting point: 50° C.
Boiling point: 200° C. (pressure: 5 Torr)
Density: 0.913 g/cm³ (Temperature: 50° C.)

(3) Fluidity
Measurement method for melt viscoelasticity
   Equipment: MCR302 (Anton Paar)
   Transformation mode: Shear mode
   Temperature range: 80-110° C. (measurements could not be carried out below 80° C. because the sample did not melt)
   Temperature increase rate: 3° C./min.
   Strain rate: 100 S⁻¹
   Measuring jig: parallel plate 50 mmφ (disposable plate)
   Environment: N₂

TABLE 2

| | Mixture 1 | Mixture 3 |
|---|---|---|
| C18DEA (parts by mass) | 100 | 90 |
| C16DEA (parts by mass) | 0 | 10 |

Kinematic Viscosity (Pa^{-s})

| | | |
|---|---|---|
| 80° C. | 1.68 × 10⁻² | 1.56 × 10⁻² |
| 90° C. | 1.24 × 10⁻² | 1.19 × 10⁻² |
| 100° C. | 9.23 × 10⁻³ | 9.01 × 10⁻³ |
| 110° C. | 7.10 × 10⁻³ | 7.00 × 10⁻³ |

The results are shown in Table 2.

As mentioned above, viscoelasticity cannot be measured at room temperature, and hence measurements were performed at 80° C. or higher.

The results were, compared to stearyldiethanolamine alone, compounding palmityldiethanolamine at 10 mass % improves fluidity (kinematic viscosity decreased), and this trend is presumed to be the same at room temperature. Therefore, it can be presumed that stearyldiethanolamine and palmityldiethanolamine migrate more quickly through the polymer resin and bleed onto to the surface of the molded body even when used in masterbatches, etc. at room temperature.

II. Evaluation of Masterbatches and Molded Bodies (Films)

1. Masterbatch Preparation

(1) Antibacterial Component
Mixture of 90 mass % of stearyldiethanolamine and 10 mass % of palmityldiethanolamine (both manufactured by Toho Chemical Industry Co., Ltd.)

(2) Resin
Linear low-density polyethylene (manufactured by Prime Polymer Co., Ltd.)
   Density: 0.920 g/cm³, MFR; 4.0 g/10 min, melting point: 117.3° C.

(3) Mixing Conditions

The concentration of the mixture of stearyldiethanolamine and palmityldiethanolamine was adjusted to 5% by mass, and the mixture was mixed with low density polyethylene under the following conditions to produce a pellet-shaped antibacterial ingredient masterbatch.
Extruder: TEX 44SS-38, 58-3V 38 mmφ twin-screw extruder manufactured by Japan Steel Works
Mixing temperature: 190° C.

2. Inflation Film Molding

(1) Resin
High-pressure low-density polyethylene (manufactured by Ube Maruzen Polyethylene Co., Ltd.)
Density: 0.920 g/cm³, MFR: 1.2 g/10 min, melting point: 109.0° C.

(2) Additives

a. Antibacterial Component

The masterbatch described above was added at 2 mass %, i.e., 1,000 ppm in terms of the concentration of stearyldiethanolamine and palmityldiethanolamine.

(5%×2 mass %=1,000 ppm)

b. Anti-Blocking Ingredients

A masterbatch of 10 wt % of silica (product name: Silicia 730 (average particle size: 3 μm) manufactured by Fuji Silicia Chemical) was used to achieve a silica concentration of 1,000 ppm.

(10%×1 wt. %=1,000 ppm)

c. Slip Component

A masterbatch of 10 wt. % erucamide (trade name: ATMERSA1753, manufactured by Ciba Specialty Chemicals, Inc.) was used and adjusted to achieve 1,000 ppm in terms of silica concentration.

(10%×1 wt. %=1,000 ppm)

(3) Inflation Film Forming Conditions

The above resin and additives were each weighed, and the film was formed using a single-layer inflation molding machine (die diameter: 250 mmφ, extruder: 55 mmφ×1) under the following conditions to obtain film as Example 1.
extrusion temperature: 60° C. to 145° C. (60° C. for only under the middle layer hopper, 145° C. for the rest);
die temperature: 160° C.;
expansion ratio: 3

The film was 50 μm thick and 1,000 mm in folded diameter.

There were no problems, such as fuming or pellets slipping in the extruder, during the molding.

There was no stickiness on the film surface, and the surface uniformly had good appearances.

Furthermore, as Comparative Example 1, films were molded without the above antibacterial ingredient masterbatch and thus having stearyl diethanolamine and palmityldiethanolamine concentrations of 0 ppm. Except for the antibacterial ingredients concentration, the conditions were the same as those in Example 1.

(4) Antibacterial Test

Antibacterial test according to JIS Z2801 was performed using Escherichia coli (E. coli) provided that no alcohol wiping was performed to maintain the film surface condition.

A specified quantity of Escherichia coli (0.4 cc of bouillon used in the JIS test) in 1/500 ordinary bouillon medium was dropped onto the surface of 4-cm square inflation film to be evaluated and placed between polyethylene films with no additives. After being kept for 24 hours at 35° C., the surface of the freshness-retaining film was washed, and the washing solution containing the above-mentioned ordinary bouillon medium was collected, which was then incubated using ordinary agar medium, and the number of colonies was counted.

Since it is difficult to count the number of bacteria under a microscope, the number of colonies was counted visually, and the number of colonies per gram (g) was defined as the viable count CFU (colony forming unit) (units [number/g]). A sample sandwiched between two polyethylene films without the specified compounds was used as a control for comparison.

Table 3 also shows the average values for n=3. However, if the variation in the measured values is 10 times or more, the average value cannot be calculated according to the JIS standard.

Antibacterial tests were performed at four equatorial locations on a film with the folded diameter of 1,000 mm (i.e., 500 mm pitch). The results are shown in Table 3. As shown in Table 3, high antibacterial activity was observed at all locations. Therefore, it can be presumed that the antibacterial component is uniformly dispersed in the circumferential direction by virtue of using the masterbatch.

(5) Appearance Evaluation

The film surface was rubbed with fingertips and evaluated for excessive bleed out based on changes in surface properties.

Table 3 shows the surface properties with and without changes as × and ∘, respectively.

The ratings for all measurement points in Example 1 were ∘, indicating that excessive bleed out was suppressed.

TABLE 3

| | Example | Example | Example | Example |
|---|---|---|---|---|
| | 1, | 1, | 1, | 1, |
| | measure- | measure- | measure- | measure- |
| | ment | ment | ment | ment |
| | point 1 | point 2 | point 3 | point 3 |
| C18DEA + | 1000 ppm | 1000 ppm | 1000 ppm | 1000 ppm |
| C16DEA | | | | |
| location | 0 mm | 500 mm | 1000 ppm | 1500 mm |

evaluation results

| | | | | | |
|---|---|---|---|---|---|
| antibacterial test | initial | 1. 4 × 10⁵ | 1.4 × 10⁵ | 1. 4 × 10⁵ | 1. 4 × 10⁵ |
| (E. coli number) | (number/g) | | | | |
| | after 24 h | <10 | <10 | <10 | <10 |
| | (n = 1) | | | | |
| | (number/g) | | | | |
| | after 24 h | <10 | <10 | <10 | <10 |
| | (n = 2) | | | | |
| | (number/g) | | | | |
| | after 24 h | <10 | <10 | <10 | <10 |
| | (n = 3) | | | | |
| | (number/g) | | | | |
| | average | <10 | <10 | <10 | <10 |
| | value | | | | |
| | (number/g) | | | | |
| | Control | 1.1 × 10⁷ | 1.1 × 10⁷ | 1.1 × 10⁷ | 1.1 × 10⁷ |

| | | | | |
|---|---|---|---|---|
| antibacterial performance | Yes | Yes | Yes | Yes |
| appearance | ○ | ○ | ○ | ○ |

On the other hand, Comparative Example 1, which does not contain stearyldiethanolamine+palmityldiethanolamine (0 ppm), did not exhibit antibacterial activity at any of the measurement points.

The results are shown in Table 4.

TABLE 4

| | | | |
|---|---|---|---|
| Com- | Com- | Com- | Com- |
| parative | parative | parative | parative |
| Ex- | Ex- | Ex- | Ex- |
| ample 1, | ample 1, | ample 1, | ample 1, |
| measure- | measure- | measure- | measure- |
| ment | ment | ment | ment |
| point 1 | point 2 | point 3 | point 4 |

| | | | | |
|---|---|---|---|---|
| C18DEA+C16DEA | 0 ppm | 0 ppm | 0 ppm | 0 ppm |
| location | 0 mm | 500 mm | 1000 ppm | 1500 mm |

evaluation results

| | | | | | |
|---|---|---|---|---|---|
| antibacterial test | initial | 1.4 × 10⁵ | 1.4 × 10⁵ | 1.4 × 10⁵ | 1.4 × 10⁵ |
| (E. coli number) | (number/g) | | | | |
| | after 24 h | 4.2 × 10⁶ | 3.9 × 10⁶ | 2.9 × 10⁶ | 3.2 × 10⁶ |
| | (n = 1) | | | | |
| | (number/g) | | | | |
| | after 24 h | 7.3 × 10⁶ | 7.1 × 10⁶ | 4.8 × 10⁶ | 6.2 × 10⁶ |
| | (n = 2) | | | | |
| | (number/g) | | | | |
| | after 24 h | 8.1 × 10⁶ | 8.8 × 10⁶ | 7.1 × 10⁶ | 9.0 × 10⁶ |
| | (n = 3) | | | | |
| | (number/g) | | | | |
| | average | 6.7 × 10⁶ | 5.1 × 10⁶ | 6.1 × 10⁶ | 4.8 × 10⁶ |
| | value | | | | |
| | (number/g) | | | | |
| | Control | 1.1 × 10⁷ | 1.1 × 10⁷ | 1.1 × 10⁷ | 1.1 × 10⁷ |

| | | | | |
|---|---|---|---|---|
| antibacterial performance | No | No | No | No |
| appearance | ○ | ○ | ○ | ○ |

III. Evaluation of Molded Body (Sheet)

1. Production of Masterbatch

(1) Antibacterial Component

A mixture of 90 mass % stearyldiethanolamine (C18 DEA)+10% palmityldiethanolamine (C16 DEA) (both from Toho Chemical Industry Co., Ltd.) was used as the antibacterial component.

(2) Resin

Depending on the resin that constitutes the molded body (sheet), the same type of resin was selected from the following as the resin component of the masterbatch.

A (Example 2): Polyethylene (Ultzex (registered trademark) 4050, manufactured by Prime Polymer Co., Ltd.)
Density: 940 kg/m³
MFR: 5.0 g/10 min (190° C., 5 kgf, ISO 1133)
Melting point: 127° C.

B (Example 3): Polypropylene (E327, manufactured by Prime Polymer Co., Ltd.)
MFR: 3.0 g/10 min (230° C., 5 kgf, ISO 1133)
Melting point: 138° C.

C (Comparative Example 2): Polystyrene (HF77, manufactured by PS Japan Corp.)
Density: 1050 kg/m³
MFR: 7.5 g/10 min (200° C., 5 kgf, ISO 1133)
Melting point: None (amorphous)

D (Example 4): 6 nylon (Amilan CM1001, manufactured by Toray Industries, Inc.)
Melting point: 225° C.

E (Comparative Example 3): PET (polyethylene terephthalate, NES-2040 manufactured by Unitika Ltd.)
Density: 1410 kg/m³
Melting point: 251° C.

(3) Mixing Conditions

The above antibacterial ingredients mixture and the above resin were mixed under the following conditions, adjusting the stearyldiethanolamine+palmityldiethanolamine mixture concentration at 5% by mass, to produce a pellet-shaped antibacterial ingredient masterbatch.

Extruder: TEX 44SS-38, 58-3V 38 mmφ twin-screw extruder manufactured by Japan Steel Works, Ltd.

Mixing temperature:
A. Polyethylene: 190° C.
B. Polypropylene: 230° C.
C. Polystyrene: 200° C.
D. 6 nylon: 240° C.
E. PET: 260° C.

2. Injection Molding

Using the following equipment, the resins A through E above were each blended with the above masterbatches of the corresponding resin in amounts to achieve the C18DEA+C16DEA concentrations (ppm) shown in Tables 5 through 9 below, and the test specimens were produced by injection molding under the conditions shown in Tables 5 through 9, below, depending on the resin type, masterbatch blending amount, etc.

Equipment used: Electric injection molding machine NEX140 (Nissei Plastic Industrial Co., Ltd.), Clamping force: 140 tf/Screw diameter: φ40/Full flight screw

Specimen shape: flat, 150 mm×150 mm×3 mm thickness

TABLE 5
Conditions and Results of Injection Molding (A: Polyethylene)

| C18DEA + | | | | | |
|---|---|---|---|---|---|
| C16DEA | | | | | |
| (ppm) | 0 | 500 | 1000 | 5000 | 10000 |
| preliminary | 80° C. × 6 h | vacuum, 40° C. × 12 h or more | | | |
| drying | | | | | |
| conditions | | | | | |
| molding | 200 | 200 | 200 | 200 | 200 |
| temperature | | | | | |
| (front part) | | | | | |
| (° C.) | | | | | |
| mold | 38-48 | 37-47 | 38-48 | 38-48 | 38-48 |
| temperature | | | | | |
| (° C.) | | | | | |
| injection | 40 | 39 | 39 | 39 | 39 |
| pressure (MPa) | | | | | |
| injection time | 6.59 | 6.59 | 6.59 | 6.59 | 6.59 |
| (sec.) | | | | | |
| holding | 40 | 40 | 40 | 40 | 40 |
| pressure (MPa) | | | | | |
| pressure | 8.41 | 8.41 | 8.41 | 8.41 | 8.41 |
| holding | | | | | |
| time (sec.) | | | | | |
| machine | 20.0 | 20.0 | 20.0 | 20.0 | 20.0 |
| setting | | | | | |
| of cooling | | | | | |
| time (sec.) | | | | | |
| cycle time | 44-45 | 44-45 | 44-45 | 44-45 | 44-45 |
| (sec.) | | | | | |

| | |
|---|---|
| specimen | flat plate, 150 mm × 150 mm × 3 mm thick |
| shape | |
| number of | 10 specimens each |
| specimens | |
| made | |

* pressure holding time = injection pressure holding time-injection time

TABLE 6
Conditions and Results of Injection Molding (B: Polypropylene)

| C18DEA + | | | | | |
|---|---|---|---|---|---|
| C16DEA (ppm) | 0 | 500 | 1000 | 5000 | 10000 |
| preliminary | 80° C. × 6 h | vacuum, 40° C. × 12 h or more | | | |
| drying conditions | | | | | |
| molding | 230 | 230 | 230 | 230 | 230 |
| temperature | | | | | |
| (front part) (° C.) | | | | | |
| mold temperature | 35-45 | 35-45 | 35-45 | 35-45 | 35-45 |
| (° C.) | | | | | |
| injection pressure | 19 | 19 | 19 | 19 | 19 |
| (MPa) | | | | | |
| injection time (sec.) | 6.49 | 6.49 | 6.49 | 6.49 | 6.49 |
| holding pressure | 30 | 30 | 30 | 30 | 30 |
| (MPa) | | | | | |
| pressure holding | 18.51 | 18.51 | 18.51 | 18.51 | 18.51 |
| time (sec.) | | | | | |
| machine setting of | 15.0 | 15.0 | 15.0 | 15.0 | 15.0 |
| cooling time (sec.) | | | | | |
| cycle time (sec.) | 49-50 | 49-50 | 49-50 | 49-50 | 49-50 |

| | |
|---|---|
| specimen shape | flat plate, 150 mm × 150 mm × 3 mm thick |
| number of | 10 specimens each |
| specimens made | |

* pressure holding time = injection pressure holding time-injection time

TABLE 7
Conditions and Results of Injection Molding (C: Polystyrene)

| C18DEA + | | | | | |
|---|---|---|---|---|---|
| C16DEA (ppm) | 0 | 500 | 1000 | 5000 | 10000 |
| preliminary drying | 80° C. × 6 h | vacuum, 40° C. × 12 h or more | | | |
| conditions | | | | | |
| molding temperature | 210 | 210 | 210 | 210 | 210 |
| (front part) (° C.) | | | | | |
| mold temperature | 30-40 | 30-40 | 30-40 | 30-40 | 30-40 |
| (° C.) | | | | | |
| injection pressure | 36 | 36 | 36 | 34 | 33 |
| (MPa) | | | | | |
| injection time (sec.) | 2.16 | 2.13 | 2.13 | 2.13 | 2.10 |
| holding pressure | 35 | 35 | 35 | 35 | 35 |
| (MPa) | | | | | |
| pressure holding | 12.84 | 12.87 | 12.87 | 12.87 | 12.90 |
| time (sec.) | | | | | |
| machine setting of | 20.0 | 20.0 | 20.0 | 20.0 | 20.0 |
| cooling time (sec.) | | | | | |
| cycle time (sec.) | 44-46 | 45-46 | 45-46 | 45-46 | 45-46 |

| | |
|---|---|
| specimen shape | flat plate, 150 mm × 150 mm × 3 mm thick |
| number of | 10 specimens each |
| specimens made | |

* pressure holding time = injection pressure holding time-injection time

TABLE 8
Conditions and Results of Injection Molding (D: 6 Nylon)

| C18DEA + | | | | | |
|---|---|---|---|---|---|
| C16DEA (ppm) | 0 | 500 | 1000 | 5000 | 10000 |
| preliminary drying | vacuum, 40° C. × 12 h or more | | | | |
| conditions | | | | | |
| molding temperature | 240 | 240 | 240 | 240 | 240 |
| (front part) (° C.) | | | | | |
| mold temperature (° C.) | 37-47 | 37-47 | 36-47 | 38-48 | 37-47 |
| injection pressure (MPa) | 22 | 22 | 22 | 21 | 20 |
| injection time (sec.) | 2.16 | 2.16 | 2.16 | 2.16 | 2.16 |
| holding pressure (MPa) | 28 | 28 | 28 | 28 | 28 |
| pressure holding time (sec.) | 12.84 | 12.84 | 12.84 | 12.84 | 12.84 |
| machine setting of | 20. 0 | 20.0 | 20.0 | 20.0 | 20.0 |
| cooling time (sec.) | | | | | |
| cycle time (sec.) | 45-46 | 45-46 | 45-46 | 45-46 | 45-46 |

| | |
|---|---|
| specimen shape | flat plate, 150 mm × 150 mm × 3 mm thick |
| number of specimens made | 10 specimens each |

* pressure holding time = injection pressure holding time-injection time

TABLE 9
Conditions and Results of Injection Molding (E: PET)

| C18DEA + | | | | | |
|---|---|---|---|---|---|
| C16DEA (ppm) | 0 | 500 | 1000 | 5000 | 10000 |
| preliminary drying | 120° C. × 6 h | vacuum, 40° C. × 12 h or more | | | |
| conditions | | | | | |
| molding temperature | 280 | 280 | 280 | 280 | 280 |
| (front part) (° C.) | | | | | |
| mold temperature | 37-47 | 37-47 | 37-47 | 37-47 | 37-47 |
| (° C.) | | | | | |
| injection | 43 | 43 | 43 | 30 | 18 |
| pressure (MPa) | | | | | |
| injection time (sec.) | 2.16 | 2.16 | 2.16 | 2.16 | 2.16 |
| holding pressure | 35 | 35 | 35 | 32 | 30 |
| (MPa) | | | | | |
| pressure holding | 12.84 | 12.84 | 12.84 | 12.84 | 12.84 |
| time (sec.) | | | | | |
| machine setting of | 20.0 | 20.0 | 20.0 | 20.0 | 20.0 |
| cooling time (sec.) | | | | | |
| cycle time (sec.) | 45-46 | 45-46 | 45-46 | 45-46 | 45-46 |

| | |
|---|---|
| specimen shape | flat plate, 150 mm × 150 mm × 3 mm thick |
| number of | 10 specimens each |
| specimens made | |

* pressure holding time = injection pressure holding time-injection time

3. Machine Processing

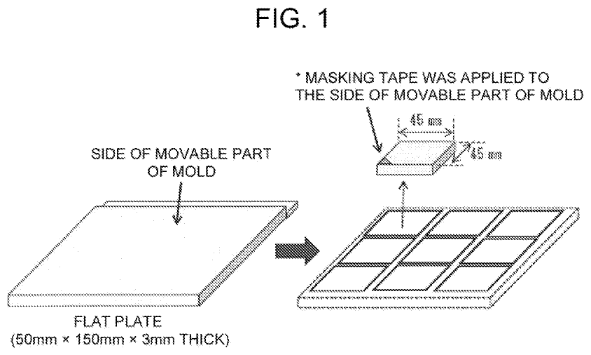

The injection molding specimens (flat plate, 150 mm×150 mm×3 mm thick) obtained in 2, above, were cut using a circular saw under the following conditions to prepare specimens for “4. measurement of surface C18 DEA+C16 DEA contents” and “5. antibacterial test”.
cutting shape: flat plate, 45 mm×45 mm×3 mm thick
cutting conditions: cut from a flat plate of 150 mm×150 mm×3 mm thick
   Processing was carried out wearing polyolefin gloves.
   Masking tape was applied to the corners of the face of the movable side of the mold (see FIG. 1).
Number of specimens cut: 9 (see FIG. 1)

4. Measurement of Surface C18 DEA+C16 DEA Amounts

Two 45 mm×45 mm designated surfaces (having masking tape) of the machine-processed specimens were washed with a solvent, and the washing solution was collected. The collected washing solution, whose volume was then adjusted as appropriate, was subjected to derivatized GC (FID) and analyzed quantitatively by the absolute calibration curve method to determine the amount of C18DEA+C16DEA on the designated surfaces of the specimens.

Specimens A through D were washed using dichloromethane as the solvent. For specimen C (polystyrene), the cleaned surface became significantly cloudy and could not be measured. For specimen E (PET), n-hexane with 5% dichloromethane was used as the cleaning solvent instead of dichloromethane.

The results are shown in Table 10.

5. Antibacterial Test

The test was conducted according to JIS 2801. Reference Examples 1 to 5 without additives were used as controls, and the logarithm of the bacterial count ratio was evaluated as the antibacterial activity.

The results are shown in Table 10.

TABLE 10-1
Example 2 polyethylene

| | Reference | Ex- | Ex- | Ex- | Ex- |
|---|---|---|---|---|---|
| | Example | ample | ample | ample | ample |
| | 1 | 2-1 | 2-2 | 2-3 | 2-4 |
| C18DEA + | 0 | 500 | 1000 | 5000 | 10000 |
| C16DEA (ppm) | | | | | |
| thickness (mm) | 3 | 3 | 3 | 3 | 3 |
| surface washing solvent | dichloromethane | | | | |
| surface amount (mg/m²) | N.D. | <5 | 10 | 1200 | 3800 |
| antibacterial activity | | | | | |
| E. coli | | | | | |
| 0 h bacterial number | 8.3E+03 | | | | |
| inoculated (cfu/cm²) | | | | | |
| average of logarithm L | 3.9 | | | | |
| 24 h (cfu/cm²) | | | | | |
| n1 | 1.2E+06 | <0.63 | <0.63 | <0.63 | <0.63 |
| n2 | 1.2E+06 | <0.63 | <0.63 | <0.63 | <0.63 |
| n3 | 1.1E+06 | <0.63 | <0.63 | <0.63 | <0.63 |
| L1 | 6.1 | −0.2 | −0.2 | −0.2 | −0.2 |
| L2 | 6.1 | −0.2 | −0.2 | −0.2 | −0.2 |
| L3 | 6.0 | −0.2 | −0.2 | −0.2 | −0.2 |
| average of logarithmi L | 6.1 | −0.2 | −0.2 | −0.2 | −0.2 |
| antibacterial activity value | | 6.3 | 6.3 | 6.3 | 6.3 |
| staphylococcus aureus | | | | | |
| 0 h bacterial number | 1.0E+04 | | | | |
| inoculated (cfu/cm²) | | | | | |
| 24 h (cfu/cm²) | | | | | |
| n1 | 3.1E+03 | <0.63 | <0.63 | <0.63 | <0.63 |
| n2 | 3.0E+03 | <0.63 | <0.63 | <0.63 | <0.63 |
| n3 | 4.0E+03 | <0.63 | <0.63 | <0.63 | <0.63 |
| average | 3.4E+03 | <0.63 | <0.63 | <0.63 | <0.63 |
| L1 | 3.5 | −0.2 | −0.2 | −0.2 | −0.2 |
| L2 | 3.6 | −0.2 | −0.2 | −0.2 | −0.2 |
| L3 | 3.5 | −0.2 | −0.2 | −0.2 | −0.2 |
| average of logarithm L | 3.5 | −0.2 | −0.2 | −0.2 | −0.2 |
| antibacterial activity value | | 3.7 | 3.7 | 3.7 | 3.7 |

TABLE 10-2
Example 3 polypropylene

| | Reference | Ex- | Ex- | Ex- | Ex- |
|---|---|---|---|---|---|
| | Example | ample | ample | ample | ample |
| | 2 | 3-1 | 3-2 | 3-3 | 3-4 |
| C18DEA + | 0 | 500 | 1000 | 5000 | 10000 |
| C16DEA (ppm) | | | | | |
| thickness (mm) | 3 | 3 | 3 | 3 | 3 |
| surface washing solvent | dichloromethane | | | | |
| surface amount (mg/m²) | N.D. | 30 | 110 | 990 | 1700 |
| antibacterial activity | | | | | |
| E. coli | | | | | |
| 0 h bacterial number | 7.9E+03 | | | | |
| inoculated (cfu/cm²) | | | | | |
| average of logarithm L | 3.9 | | | | |
| 24 h (cfu/cm²) | | | | | |
| n1 | 1.4E+06 | <0.63 | <0.63 | <0.63 | <0.63 |
| n2 | 1.5E+06 | <0.63 | <0.63 | <0.63 | <0.63 |
| n3 | 8.9E+05 | <0.63 | <0.63 | <0.63 | <0.63 |
| L1 | 6.1 | −0.2 | −0.2 | −0.2 | −0.2 |
| L2 | 6.2 | −0.2 | −0.2 | −0.2 | −0.2 |
| L3 | 5.9 | −0.2 | −0.2 | −0.2 | −0.2 |
| average of logarithm L | 6.1 | −0.2 | −0.2 | −0.2 | −0.2 |
| antibacterial activity value | | 6.3 | 6.3 | 6.3 | 6.3 |
| staphylococcus aureus | | | | | |
| 0 h bacterial number | 1.1E+04 | | | | |
| inoculated (cfu/cm²) | | | | | |
| 24 h (cfu/cm²) | | | | | |
| n1 | 8.4E+03 | <0.63 | <0.63 | <0.63 | <0.63 |
| n2 | 1.5E+03 | <0.63 | <0.63 | <0.63 | <0.63 |
| n3 | 4.0E+04 | <0.63 | <0.63 | <0.63 | <0.63 |
| average | 1.7E+04 | <0.63 | <0.63 | <0.63 | <0.63 |
| L1 | 3.9 | −0.2 | −0.2 | −0.2 | −0.2 |
| L2 | 3.2 | −0.2 | −0.2 | −0.2 | −0.2 |
| L3 | 4.6 | −0.2 | −0.2 | −0.2 | −0.2 |
| average of logarithm L | 3.9 | −0.2 | −0.2 | −0.2 | −0.2 |
| antibacterial activity value | | 4.1 | 4.1 | 4.1 | 4.1 |

TABLE 10-3
Comparative Example 2 polystyrene

| | Reference | Comparative | Comparative | Comparative | Comparative |
|---|---|---|---|---|---|
| | Example | Example | Example | Example | Example |
| | 3 | 2-1 | 2-2 | 2-3 | 2-4 |
| C18DEA + | 0 | 500 | 1000 | 4000 | 5000 |
| C16DEA (ppm) | | | | | |
| thickness (mm) | 3 | 3 | 3 | 3 | 3 |
| surface washing | dichloromethane | | | | |
| solvent | | | | | |
| surface amount | Un- | Un- | Un- | Un- | Un- |
| (mg/m²) | measurable | measurable | measurable | measurable | measurable |
| antibacterial activity | | | | | |
| E. coli | | | | | |
| 0 h bacterial number | 7.9E+03 | | | | |
| inoculated (cfu/cm²) | | | | | |
| average of logarithm L | 3.9 | | | | |
| 24 h (cfu/cm²) | | | | | |
| n1 | 1.1E+06 | 9.3E+05 | 1.4E+06 | 1.6E+07 | 1.5E+07 |
| n2 | 1.1E+06 | 9.9E+05 | 1.0E+06 | 1.3E+07 | 1.1E+07 |
| n3 | 1.2E+06 | 1.2E+06 | 9.9E+05 | 1.2E+07 | 1.8E+07 |
| L1 | 6.0 | 6.0 | 6.1 | 7.2 | 7.2 |
| L2 | 6.0 | 6.0 | 6.0 | 7.1 | 7.0 |
| L3 | 6.1 | 6.1 | 6.0 | 7.1 | 7.3 |
| average of logarithm L | 6.1 | 6.0 | 6.0 | 5.9 | 5.9 |
| antibacterial activity value | | 0.1 | 0.1 | 0.2 | 0.2 |
| staphylococcus aureus | | | | | |
| 0 h bacterial number | 9.9E+03 | | | | |
| inoculated (cfu/cm²) | | | | | |
| 24 h (cfu/cm²) | 4.0 | | | | |
| n1 | 2.2E+04 | 3.9E+03 | 8.4E+03 | 1.7E+04 | 7.5E+03 |
| n2 | 2.6E+04 | 1.2E+04 | 3.7E+03 | 4.1E+03 | 1.0E+04 |
| n3 | 4.3E+04 | 2.6E+03 | 4.0E+03 | 1.0E+04 | 2.0E+04 |
| average | 3.0E+04 | 6.2E+03 | 5.4E+03 | 1.0E+04 | 1.3E+04 |
| L1 | 4.3 | 3.6 | 3.9 | 4.2 | 3.9 |
| L2 | 4.4 | 4.1 | 3.6 | 3.6 | 4.0 |
| L3 | 4.6 | 3.4 | 3.6 | 4.0 | 4.3 |
| average of logarithm L | 4.5 | 3.7 | 3.7 | 3.9 | 4.1 |
| antibacterial activity value | | 0.8 | 0.8 | 0.6 | 0.4 |

TABLE 10-4
Example 4 6 Nylon

| | Reference | Ex- | Ex- | Ex- | Ex- |
|---|---|---|---|---|---|
| | Example | ample | ample | ample | ample |
| | 4 | 4-1 | 4-2 | 4-3 | 3-4 |
| C18DEA + | 0 | 500 | 1000 | 5000 | 10000 |
| C16DEA (ppm) | | | | | |
| thickness (mm) | | 3 | 3 | 3 | 3 |
| surface washing solvent | dichloromethane | | | | |
| surface amount (mg/m²) | N.D. | <5 | < 5 | 20 | 40 |
| antibacterial activity | | | | | |
| E. coli | | | | | |
| 0 h bacterial number | 7.9E+03 | | | | |
| inoculated (cfu/cm²) | | | | | |
| average of logarithm L | 3.9 | | | | |
| 24 h (cfu/cm²) | | | | | |
| n1 | 1.9E+05 | 2.6E+03 | <0.63 | <0.63 | <0.63 |
| n2 | 3.2E+05 | 5.2E+03 | <0.63 | <0.63 | <0.63 |
| n3 | 4.4E+05 | 3.8E+00 | <0.63 | 7.9E+01 | <0.63 |
| L1 | 5.3 | 3.4 | −0.2 | −0.2 | −0.2 |
| L2 | 5.5 | 3.7 | −0.2 | −0.2 | −0.2 |
| L.3 | 5.6 | 0.6 | −0.2 | 1.9 | −0.2 |
| average of logarithm L | 5.5 | 2.6 | −0.2 | 0.5 | −0.2 |
| antibacterial activity value | | 2.9 | 5.7 | 5.0 | 5.7 |
| staphylococcus aureus | | | | | |
| 0 h bacterial number | 1.0E+04 | | | | |
| inoculated (cfu/cm²) | | | | | |
| 24 h (cfu/cm²) | 4.0 | | | | |
| n1 | 4.0E+03 | <0.63 | <0.63 | <0.63 | <0.63 |
| n2 | 6.9E+02 | 4.0E+02 | <0.63 | <0.63 | <0.63 |
| n3 | 6.6E+02 | <0.63 | <0.63 | <0.63 | <0.63 |
| average | 1.8E+03 | 1.3E+02 | <0.63 | <0.63 | <0.63 |
| L1 | 3.6 | −0.2 | −0.2 | −0.2 | −0.2 |
| L2 | 2.8 | 2.6 | −0.2 | −0.2 | −0.2 |
| L3 | 2.8 | −0.2 | −0.2 | −0.2 | −0.2 |
| average of logarithm L | 3.1 | 0.7 | −0.2 | −0.2 | −0.2 |
| antibacterial activity value | | 2.4 | 3.3 | 3.3 | 3.3 |

TABLE 10-5
Comparative Example 3 PET

| | Re- | Com- | Com- | Com- | Com- |
|---|---|---|---|---|---|
| | ference | parative | parative | parative | parative |
| | Example | Example | Example | Example | Example |
| | 5 | 3-1 | 3-2 | 3-3 | 3-4 |
| C18DEA + | 0 | 500 | 1000 | 5000 | 10000 |
| C16DEA (ppm) | | | | | |
| thickness (mm) | 3 | 3 | 3 | 3 | 3 |
| surface washing solvent | n-hexane containing 5% of dichloromethane | | | | |
| surface amount (mg/m²) | N.D. | N.D | N.D | N.D. | N.D |
| antibacterial activity | | | | | |
| E. coli | | | | | |
| 0 h bacterial number | 7.8E+03 | | | | |
| inoculated (cfu/cm²) | | | | | |
| average of logarithm L | 3.9 | | | | |
| n1 | 1.2E+06 | 1.2E+06 | 1.3E+06 | 1.1E+06 | 1.4E+06 |
| n2 | 1.2E+06 | 1.2E+06 | 1.1E+06 | 1.2E+06 | 1.3E+06 |
| n3 | 1.3E+06 | 1.3E+06 | 1.2E+06 | 1.3E+06 | 1.3E+06 |
| L1 | 6.1 | 6.1 | 6.1 | 6.0 | 6.1 |
| L2 | 6.1 | 6.1 | 6.0 | 6.1 | 6.1 |
| L3 | 6.1 | 6.1 | 6.1 | 6.1 | 6.1 |
| average of logarithm L | 6.1 | 6.1 | 6.1 | 6.1 | 6.1 |
| antibacterial activity | | 0.0 | 0.0 | 0.0 | 0.0 |
| value | | | | | |
| staphylococcus aureus | | | | | |
| 0 h bacterial number | 1.0E+04 | | | | |
| inoculated (cfu/cm²) | | | | | |
| 24 h (cfu/cm²) | 4.0 | | | | |
| n1 | 2.3E+03 | 2.6E+03 | 3.8E+03 | 2.7E+03 | 4.0E+03 |
| n2 | 2.2E+03 | 5.5E+03 | 2.6E+03 | 1.7E+03 | 4.0E+03 |
| n3 | 2.4E+03 | 2.5E+03 | 6.4E+03 | 6.2E+03 | 2.8E+03 |
| average | 2.3E+03 | 3.5E+03 | 4.3E+03 | 3.5E+03 | 3.6E+03 |
| L1 | 3.4 | 3.4 | 3.6 | 3.4 | 3.6 |
| L2 | 3.3 | 3.7 | 3.4 | 3.2 | 3.6 |
| L3 | 3.4 | 3.4 | 3.8 | 3.8 | 3.4 |
| average of logarithm L | 3.4 | 3.5 | 3.6 | 3.5 | 3.6 |
| antibacterial activity | | −0.1 | −0.2 | −0.1 | −0.2 |
| value | | | | | |

In Examples 2 to 4 using polyethylene, polypropylene, or nylon, high antibacterial activity of 2 or higher was confirmed in systems with C18DEA+C16DEA added at 500 ppm or higher. Also, the surface C18DEA+C16DEA content was higher than ND (lower limit of detection), and hence good bleed out property was observed.

On the other hand, in the cases of polystyrene and PET, antibacterial activity was not exhibited even when up to 10,000 ppm of C18DEA+C16DEA were added.

Although the cause of these phenomena is not necessarily clear, it is presumed that the mechanism of accelerated bleed out in polyolefins and polyamides described above was at work.

### INDUSTRIAL APPLICABILITY

The resin molded body of the present invention can impart excellent antimicrobial and antiviral performance to molded bodies of relatively complex shapes, and because of its excellent appearance and antimicrobial properties, it is suitable for use in components with relatively complex shapes and frequent direct contact with the user's body, such as toilet seats, pens, door knobs, etc. Therefore, it has high applicability in various industrial fields, such as daily necessities, construction, healthcare, agriculture, food processing, distribution, and food services.

1. A resin molded body comprising a polymer resin, and stearyldiethanolamine and palmityldiethanolamine, wherein the content of palmityldiethanolamine is 2 to 25 parts by mass based on 100 parts by mass of the sum of the stearyldiethanolamine and the palmityldiethanolamine, and the polymer resin comprises a polyolefin or a polyamide.

2. The resin molded body according to claim 1, wherein the polymer resin comprises at least one selected from the group consisting of polyethylene, polypropylene and nylon.

3. The resin molded body according to claim 1 or 2, wherein the resin molded body is a sheet, an injection molded body, a foam or a blow molded body.

4. The resin molded body according to any one of claims 1 to 3, wherein the total content (in terms of mass) of the stearyldiethanolamine and the palmityldiethanolamine is from 50 ppm to 5.0%.

5. A process for producing a resin molded body according to any one of claims 1 to 4, comprising the step of further mixing a masterbatch comprising polymer resin 1, which is a polyolefin or a polyamide, and stearyldiethanolamine and palmityldiethanolamine, wherein the palmityldiethanolamine content is 2 to 25 parts by mass based on 100 parts by mass of the sum of the stearyldiethanolamine and the palmityldiethanolamine; with polymer resin 2 which is polyolefin or a polyamide.

6. The method for producing a resin molded body according to claim 5, wherein the masterbatch comprises 3 to 30 mass % of the sum of the stearyldiethanolamine and the palmityldiethanolamine.

7. A masterbatch comprising polymer resin 1, which is a polyolefin or a polyamide, and stearyldiethanolamine and palmityldiethanolamine, wherein the palmityldiethanolamine content is 2 to 25 parts by mass based on 100 parts by mass of the sum of the stearyldiethanolamine and the palmityldiethanolamine.

8. The masterbatch according to claim 7, containing 3 to 30% by mass of the sum of the stearyldiethanolamine and palmityldiethanolamine.
